(19) United States
(12) Patent Application Publication
(10) Pub. No.: US 2002/0143697 A1
(43) Pub. Date: Oct. 3, 2002

(54) Method and apparatus for transferring a credit

(76) Inventor: Bradley L. Gotfried, Hobe Sound, FL (US)

Correspondence Address: AKERMAN, SENTERFITT & EIDSON, P.A., Esperante Building, Suite 400, Post Office Box 3188, 222 Lakeview Avenue, West Palm Beach, FL, 33402-3188, US

(21) Appl. No.: 09/821,910

(22) Filed: Mar. 30, 2001

(51) Int. Cl. G06F 17/60

(52) U.S. Cl. 705/39

(57) ABSTRACT

A greeting card assembly is provided with a greeting card, the greeting card having indicia for encoding a gift certificate. The indicia is preferably provided on a removable gift card. Goods or services, or monetary credit for goods and services, are given to the recipient upon presentation by the recipient of the indicia. A method for transmitting credits from a giver to a recipient is also disclosed.

### FIELD OF THE INVENTION

This invention relates generally to credits for goods and services, and more particularly to a method and apparatus for transferring such credits to recipients.

### BACKGROUND OF THE INVENTION

Credits, or the purchase of goods and services, have become a popular gift item because such credits are available in varying credit amounts and permit the recipient to apply the credit to the purchase of goods and services which are preferred by the recipient. Thus, the purchaser does not have to make a selection of goods or services for the benefit of the recipient. The credit amount can be applied to purchase different goods, or as a credit against the cost of goods or services in excess of the credit amount, or can be combined with other gift credits. In some instances, the credits can be for selected goods or services sold by the seller of the credit, or can be for any goods or services sold by the seller, or other sellers.

Gift cards typically are made of plastic in the form of traditional credit cards, and have structure for encoding the credit in a machine-readable format. This encoding structure is most commonly in the form of a magnetic strip, which is encoded by known methods to activate the card and/or to also code the card for the particular credit that has been purchased. The credit is typically a purchase amount which the recipient can apply to the purchase of goods and services in the amount indicated by the credit. In many instances, these cards are reusable, such that if the total amount of the credit is not used in an initial purchase, the remaining amount may be used in a subsequent purchase.

Gift cards are typically provided to recipients without gift wrapping, as gift wrapping a small gift card is difficult, even if the gift card is mounted on a cardboard or plastic backing. Also, in the context of making a gift, a greeting card frequently must be purchased separately. In such event, the gift card must either be removed from the backing and placed in the greeting card, or wrapped separately. If placed in the greeting card, the gift card lies loose, can fall out when the card is removed from the envelope, and does not provide a pleasing presentation.

### SUMMARY OF THE INVENTION

A greeting card assembly according to the invention comprises a gift card having indicia for encoding a gift credit. A greeting card is provided with engagement structure for removably engaging the gift card. The gift card can be encoded according to the wishes of the giver, or in predetermined credit amounts. The gift card preferably includes a magnetic strip for encoding the gift credit, such that the gift card can be encoded with varying amounts or types of credits. Alternatively, the gift card can be encoded with indicia which is entered into a computer system which identifies the recipient and the amount and/or type of credit and awards the credit to the recipient.

The structure for removably engaging the gift card preferably comprises a pocket or slotted engagement portion on the gift card for removably engaging the gift card. The gift card is preferably made of a plastic or paper body, generally in the dimensions of a typical credit or debit card, and fits within the slotted engagement portion. Alternatively, the gift card can be removably adhered to the gift card by an appropriate adhesive.

A system for transferring a credit to a recipient includes a greeting card having indicia for encoding the credit, and a website for access by the recipient. The website has computer programming which awards the credit to the recipient upon the transmission of the indicia by the recipient, or by a merchant, to the website.

A method for transferring a credit to a recipient includes the steps of providing to the recipient a greeting card with a detachable gift card. The gift card has indicia for encoding the credit. The greeting card is given to the recipient, whereupon the recipient can apply the card towards the purchase of goods or services. According to a further embodiment of the invention, the gift card is encoded with the indicia at the point of purchase of the card, according to the wishes of the giver and the purchase amount. The gift card is encoded and then engaged to the greeting card, which are then given together by the giver to the recipient. The credit can be used by the recipient for the purchase of particular goods and services.

### BRIEF DESCRIPTION OF THE DRAWINGS

There are shown in the drawings embodiments which are presently preferred, it being understood, however, that the invention is not limited to the precise arrangements and instrumentalities shown, wherein:

FIG. 1 is a perspective view of a greeting card assembly according to the invention.

FIG. 2 is a rear plan view of a gift card according to the invention.

FIG. 3 is a perspective view, partially broken away, of a first embodiment of a greeting card assembly according to the invention.

FIG. 4 is a side elevation of a second embodiment.

FIG. 5 is a perspective view of a second embodiment.

FIG. 6A-C are schematic diagrams illustrating the purchase, giving, and redemption of a greeting card assembly according to the invention.

### DETAILED DESCRIPTION OF THE PREFERRED EMBODIMENTS

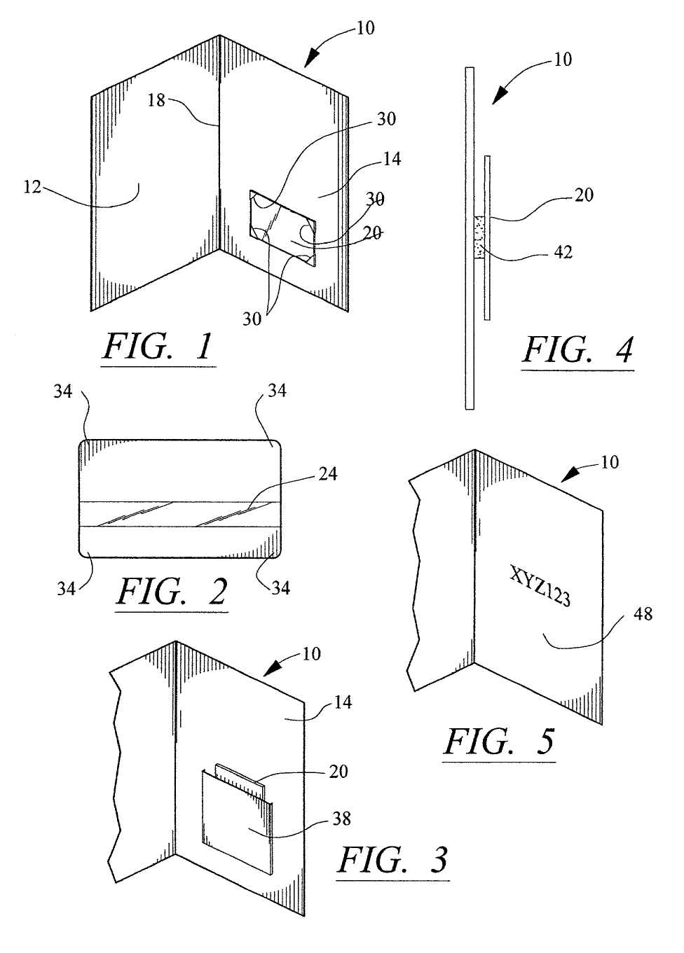

A greeting card 10 according to the invention is shown in FIG. 1. The greeting card 10 comprises at least a front portion 12 and a back portion 14, separated by a crease 18, although other greeting card designs are known in the art and within the invention. The greeting card 10 comprises a gift card 20 that is removably secured to the greeting card 10. The gift card 20 includes indicia for encoding a gift credit.

The indicia for encoding a gift credit can be any suitable form, but preferably is in the form of magnetic coding on a magnetic strip 24. The magnetic strip 24 can be coded by methods known in the art with information about the credit. This information can be the monetary amount of the credit, or the goods or services that can be purchased with the credit and the stores or locations where the credit can be used. Other information can also be contained therein, including the store, date of purchase, purchaser and the like. The gift card 20 can be in any suitable form and made from any suitable material, but is preferably of the size and shape of a standard credit or debit card. The gift card 20 can be made from suitable materials such as plastic or coated paper. Other forms of gift cards are also possible.

The gift card 20 can be secured to the greeting card 10 by any suitable means. In a preferred embodiment, the gift card 20 is provided with an engagement structure suitable for removably engaging the gift card 20. One such suitable engagement structure contains slots 30 which are provided in the greeting card 10. The corners 34 of the gift card 20 are positioned in the slots 30 so as to secure the gift card 20 to the greeting card 10.

Other methods for securing the gift card 20 to the greeting card 10 are also possible. There is shown in FIG. 3 a pocket 38 into which the greeting card 20 can be removably secured. In FIG. 4, there is shown a greeting card 10 to which the gift card 20 has been secured by a suitable adhesive 42. The adhesive 42 is a weak adhesive such that the gift card 20 can be readily removed from the greeting card 10.

An alternative embodiment of the invention is shown in FIG. 5. In the embodiment shown in FIG. 5, the greeting card 10 has indicia such as alphanumeric indicia 48 printed or otherwise embossed directly thereon. It is alternatively possible to place the indicia 48 on the greeting card 10 by other means, such as labels and the like. It is further possible to secure the indicia from view, as by applying scratch-off coatings over the indicia 48. The indicia 48 is a code which identifies the credit which has been purchased for a given recipient. A suitable computer, data storage, and access programming are utilized such that, when the indicia is provided to the store or seller by the recipient, the indicia can be used to recall from a computer memory the type or amount of credit which has been purchased by the giver for the recipient.

The invention is readily adaptable to internet-based transactions. The giver purchases the credit either at a store or through an internet based consumer transaction. The greeting card 10 is provided with certain indicia 48. The giver purchases either a certain monetary amount of credit for the recipient, or alternatively can purchase particular goods and services for the recipient which are identified by the indicia 48. Upon receipt of the greeting card 10, the recipient either brings the greeting card 10 and/or gift card 20 to the store or enters the indicia directly through an internet-based transaction. In either event, the indicia 48 is used to recall from computer memory the monetary amount or particular goods and services represented by the indicia which were purchased by the giver for the recipient. The recipient can then purchase goods and services with the monetary amount of the credit, or can purchase the particular goods and services that are specified by the credit.

A website can be provided for access by the recipient. The website includes a computer program for communicating the credit to the recipient upon the transmission of the indicia to the website by the recipient. It will be appreciated that this indicia can be either printed on the greeting card 10, or can be provided on a gift card 20 or can be provided by any other suitable means for conveying the indicia to the recipient.

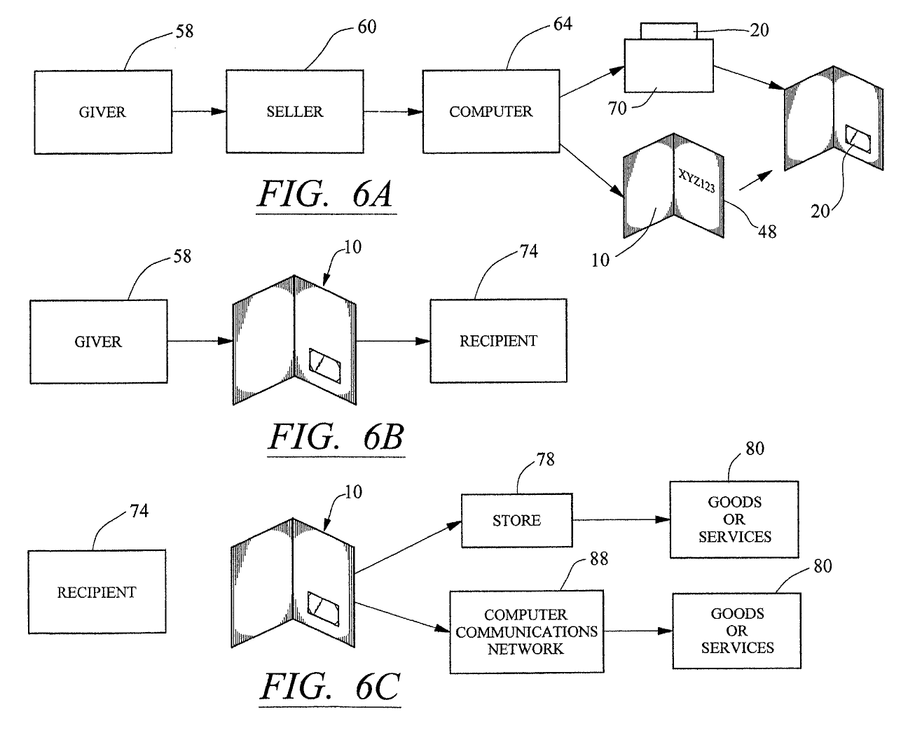

A method for providing a credit from a giver to a recipient is illustrated in FIGS. 6A-C. There is shown schematically in FIG. 6 a seller 60 which can be either a store or a website. In either case, the giver 58 purchases a monetary amount of a credit, or purchases particular goods and services for a given monetary amount. The monetary amount or goods and services of the credit are transmitted to a computer 64 which records the transaction and records the indicia 48 to represent the transaction. This indicia 48 can be applied to the gift card 20 through suitable magnetic encoding apparatus 70 (FIG. 6A), after which the gift card 20 is placed in the greeting card 10. Alternatively, the indicia 48 can be printed directly on the gift card 10 or applied by suitable structures such as labels and the like. The greeting card 10 is then given by the giver 58 to the recipient 74 (FIG. 6B). The recipient 74 takes the card 10 and delivers it either to the store 78 where it is read by suitable decoding apparatus such as a magnetic reader or computer 64 calling from memory the credit represented by the indicia 48. The recipient can then purchase goods or services 80. Alternatively, the recipient 74 can use the card 10 to enter indicia onto an appropriate website 88, from which goods or services 80 can be purchased.

This invention can be embodied in other forms without departing from the spirit or essential attributes thereof. Accordingly, reference should be had to the following claims, rather than to the foregoing specification, as indicating the scope of the invention:

I claim:

1. A greeting card assembly, comprising:
a gift card having indicia for encoding a gift credit; and,
a greeting card having engagement structure for removably engaging said gift card.

2. The greeting card assembly of claim 1, wherein said gift card comprises a magnetic strip for encoding said gift credit.

3. The greeting card assembly of claim 2, wherein said gift card comprises a plastic body portion.

4. The greeting card assembly of claim 1, wherein said structure for removably engaging said gift card comprises an adhesive.

5. The greeting card assembly of claim 1, wherein said structure for removably engaging said gift card comprises a pocket.

6. The greeting card assembly of claim 1, wherein said structure for removably engaging sad gift card comprises slotted portions on said greeting card for engaging the corners of said gift card.

7. A system for transferring a credit from a giver to a recipient, comprising:
a greeting card having indicia for encoding said credit;
a website for access by said recipient;
said website comprising a computer program for awarding said credit to said recipient upon the transmission of said indicia to said website.

8. The system of claim 7, wherein said indicia is presented on said greeting card.

9. The system of claim 7, wherein said indicia is encoded on a gift card that is removably engaged to said greeting card.

10. The system of claim 9, wherein said gift card comprises a magnetic strip for encoding said indicia.

11. A method for transmitting a credit from a giver to a recipient, comprising the steps of:
providing to said recipient a greeting card having indicia for encoding said credit; and
transferring to said recipient said credit specified by said encoded indicia when said recipient presents said encoded indicia.

12. The method of claim 11, wherein said indicia is recorded on a gift card.

13. The method of claim 12, further comprising the step of receiving from the giver consideration for said gift card and said greeting card, and encoding said indicia on said gift card according to a selection by said giver.

14. The method of claim 13, wherein said credit is recorded on a magnetic strip provided on said gift card.
